(19) United States
(12) Patent Application Publication
(10) Pub. No.: US 2013/0076212 A1
(43) Pub. Date: Mar. 28, 2013

(54) SWITCHED RELUCTANCE MOTOR

(71) Applicants: Chang Hwan PARK, Suwon (KR); Tae Ho YUN, Hwaseong-si (KR); Young Bok YOON, Yongin-si (KR); Sang Jong LEE, Suwon (KR); Hee Soo YOON, Suwon (KR); Han Kyung BAE, Seongnam-si (KR); Su Bong JANG, Anyang-si (KR)

(72) Inventors: Chang Hwan PARK, Suwon (KR); Tae Ho YUN, Hwaseong-si (KR); Young Bok YOON, Yongin-si (KR); Sang Jong LEE, Suwon (KR); Hee Soo YOON, Suwon (KR); Han Kyung BAE, Seongnam-si (KR); Su Bong JANG, Anyang-si (KR)

(73) Assignee: SAMSUNG ELECTRO-MECHANICS CO., LTD., Gyunggi-do (KR)

(21) Appl. No.: 13/458,419

(22) Filed: Apr. 27, 2012

(30) Foreign Application Priority Data
Sep. 28, 2011 (KR) 10-2011-0098182

(51) Int. Cl. H02K 9/06

(52) U.S. Cl. 310/60 R

(57) ABSTRACT

Disclosed herein is a switched reluctance motor including: a stator part including a plurality of salient poles formed at an inner peripheral surface thereof and coils wound around the salient poles; and a rotor part rotatably inserted into an inner portion of the stator part to thereby rotate in one direction by a reluctance torque, wherein the rotor part includes: a rotor including a rotor core provided with a shaft hole into which a shaft is inserted and a plurality of rotor salient poles formed to be protruded from the rotor core so as to face the salient poles of the stator part; and a blade part disposed between the rotor salient poles to thereby generate a fluid flow in a direction of the shaft.

### CROSS REFERENCE TO RELATED APPLICATION

This application claims the benefit of Korean Patent Application No. 10-2011-0098182, filed on Sep. 28, 2011, entitled “Switched Reluctance Motor”, which is hereby incorporated by reference in its entirety into this application.

### BACKGROUND OF THE INVENTION

1. Technical Field

The present invention relates to a switched reluctance motor.

2. Description of the Related Art

Generally, a switched reluctance motor is configured to include a stator part 10 including a plurality of fixed salient poles 11 and a rotor 20 including a plurality of rotating salient poles 22 facing the plurality of fixed salient poles 11 as shown in FIG. 1.

More specifically, the stator part 10 is configured to include the plurality of fixed salient poles 11 formed to be protruded at predetermined intervals in a circumferential direction of an inner peripheral surface thereof so as to face the rotor 20 and coils 12 wound around each of the fixed salient poles 11.

In addition, the rotor 20 is formed by stacking cores 21 from which the plurality of rotating salient poles 22 facing the respective fixed salient poles 11 are formed to be protruded at predetermined intervals in a circumferential direction.

Further, a shaft 30 transferring driving force of the motor to the outside is coupled to the center of the rotor 20 to thereby integrally rotate together with the rotor 20.

In addition, a concentrated type coil 12 is wound around the fixed salient poles 11. On the other hand, the rotor 20 is configured of only an iron core without any type of excitation device, for example, a winding of a coil or a permanent magnet.

Therefore, when current flows in the coil 12 from the outside, a reluctance torque moving the rotor 20 toward the fixed salient poles 11 having the coil 12 wound therearound by magnetic force generated from the coil 12 is generated, such that the rotor 20 rotates in a direction in which resistance of a magnetic circuit is minimized.

This switched reluctance motor has a cheap cost, such that it may be used in various industrial fields. Particularly, the switched reluctance motor may be mounted in a vacuum cleaner to thereby be used to suck fluid.

However, in the case in which the switched reluctance motor according to the related art is operated for a long period of time, significant heat is generated at an inner portion of the motor, such that the motor is damaged.

In addition, air circulation is conducted at the inner portion of the motor to some degree by rotation of the rotor 20, which has a limitation in spontaneously cooling heat generated at the inner portion of the motor. As a result, cooling characteristics of the motor are deteriorated, and reliability of a product be also deteriorated.

Further, when the switched reluctance motor is used in a product having a function of sucking external fluid such as a vacuum cleaner, there is a problem in providing a predetermined level of required fluid suction force.

Furthermore, in the case of increasing rotational force of the motor in order to increase the fluid suction force, the motor is further overheated to be damaged.

### SUMMARY OF THE INVENTION

The present invention has been made in an effort to provide a switched reluctance motor including a blade disposed between rotor salient poles in order to generate a fluid flow in a direction of a shaft.

According to a preferred embodiment of the present invention, there is provided a switched reluctance motor including: a stator part including a plurality of salient poles formed at an inner peripheral surface thereof and coils wound around the salient poles; and a rotor part rotatably inserted into an inner portion of the stator part to thereby rotate in one direction by a reluctance torque, wherein the rotor part includes: a rotor including a rotor core provided with a shaft hole into which a shaft is inserted and a plurality of rotor salient poles formed to be protruded from the rotor core so as to face the salient poles of the stator part; and a blade part disposed between the rotor salient poles to thereby generate a fluid flow in a direction of the shaft.

The blade part may include: a first blade part provided with a hollow hole corresponding to the shaft hole and including a first blade body coupled to an upper portion of the rotor and a plurality of first blades formed to be protruded from the first blade body; and a second blade part provided with a hollow hole corresponding to the shaft hole and including a second blade body coupled to a lower portion of the rotor and a plurality of second blades formed to be protruded from the second blade body.

the blade part may be formed by vertically connecting the first blade configuring the first blade part and the second blade configuring the second blade part to each other.

The first blade body may cover a portion of an outer peripheral surface between the rotor salient poles.

The first blade may be formed to be protruded from a region of the first blade body covering a portion of the outer peripheral surface between the rotor salient poles to thereby be disposed on a side of the rotor salient pole.

The second blade body may cover a portion of an outer peripheral surface between the rotor salient poles.

The second blade may be formed to be protruded from a region of the second blade body covering a portion of the outer peripheral surface between the rotor salient poles to thereby be disposed on a side of the rotor salient pole.

The blade part may include: an upper blade body provided with a hollow hole corresponding to the shaft hole, coupled to an upper portion of the rotor, and having a partial region covering an outer peripheral surface between the rotor salient poles; and a plurality of blades formed to be protruded from a region of the upper blade body positioned between the rotor salient poles to thereby be disposed on a side of the rotor salient pole.

The rotor part may further include a balancing part made of a non-magnetic insulating material and provided with a hollow hole corresponding to the shaft hole to thereby be coupled to a lower portion of the rotor core.

The blade part may include: a lower blade body provided with a hollow hole corresponding to the shaft hole, coupled to a lower portion of the rotor, and having a partial region covering an outer peripheral surface between the rotor salient poles; and a plurality of blades formed to be protruded from a region of the lower blade body positioned between the rotor salient poles to thereby be disposed on a side of the rotor salient pole.

The rotor part may further include a balancing part made of a non-magnetic insulating material and provided with a hollow hole corresponding to the shaft hole to thereby be coupled to an upper portion of the rotor core.

The first blade part may further include a plurality of salient poles formed to be protruded from the first blade body so as to be disposed between the first blades of the first blade part.

The second blade part may further include a plurality of salient poles formed to be protruded from the second blade body so as to be disposed between the second blades of the second blade part.

The blade part may include: a first blade part including a first blade body provided with a hollow hole corresponding to the shaft hole, coupled to an upper portion of the rotor, and having a partial region covering an outer peripheral surface between the rotor salient poles and a plurality of salient poles formed to be protruded from a region of the first blade body positioned between the rotor salient poles; and a second blade part including a second blade body provided with a hollow hole corresponding to the shaft hole, coupled to a lower portion of the rotor, and having a partial region covering an outer peripheral surface between the rotor salient poles and a plurality of salient poles formed to be protruded from a region of the second blade body positioned between the rotor salient poles.

In the blade part, the plurality of salient poles formed to be protruded from the first blade body and the plurality of salient poles formed to be protruded from the second blade body may be vertically connected to each other to thereby form a plurality of blade salient poles.

In the blade part, a surface of the blade contacting fluid introduced in the direction of the shaft may have a linear shape.

In the blade part, a surface of the blade contacting fluid introduced in the direction of the shaft may be formed to be concave toward the rotor salient pole coupled to a side of the blade to thereby have a rounded curved shape.

In the blade part, a surface of the blade contacting fluid introduced in the direction of the shaft may be formed to be convex toward another facing blade to thereby have a rounded curved shape.

### BRIEF DESCRIPTION OF THE DRAWINGS

FIG. 1 is a plan view of a switched reluctance motor according to the prior art;

FIG. 2 is a schematic exploded perspective view of a switched reluctance motor according to a preferred embodiment of the present invention;

FIG. 3 is a schematic assembled perspective view of the switched reluctance motor shown in FIG. 2;

FIG. 4 is a schematic plan view of the switched reluctance motor shown in FIG. 2;

FIG. 5 is a view showing an inner portion of a vacuum cleaner in which the switched reluctance motor shown in FIG. 2 is mounted;

FIG. 6 is an exploded perspective view showing a first example of a blade part according to the preferred embodiment of the present invention;

FIG. 7 is an exploded perspective view showing a second example of a blade part according to the preferred embodiment of the present invention;

FIG. 8 is an exploded perspective view showing a third example of a blade part according to the preferred embodiment of the present invention;

FIG. 9 is an assembled perspective view showing a fourth example of a blade part according to the preferred embodiment of the present invention;

FIG. 10 is an assembled perspective view showing a fifth example of a blade part according to the preferred embodiment of the present invention;

FIGS. 11A to 11C are perspective views showing various examples of a shape of a blade according to the preferred embodiment of the present invention;

FIG. 12 is an analyzing view analyzing suction force of a rotor according to the preferred embodiment of the present invention; and

FIGS. 13A to 13C are analyzing views analyzing suction force of a rotor according to a change in introduction speed of fluid according to the preferred embodiment of the present invention.

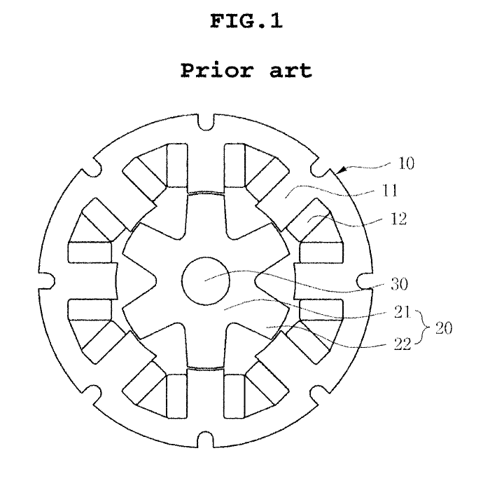

### DESCRIPTION OF THE PREFERRED EMBODIMENTS

Various objects, advantages and features of the invention will become apparent from the following description of embodiments with reference to the accompanying drawings. In the specification, in adding reference numerals to components throughout the drawings, it is to be noted that like reference numerals designate like components even though components are shown in different drawings. Further, terms used in the specification, ‘first’, ‘second’, etc. can be used to describe various components, but the components are not to be construed as being limited to the terms. The terms are only used to differentiate one component from other components. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

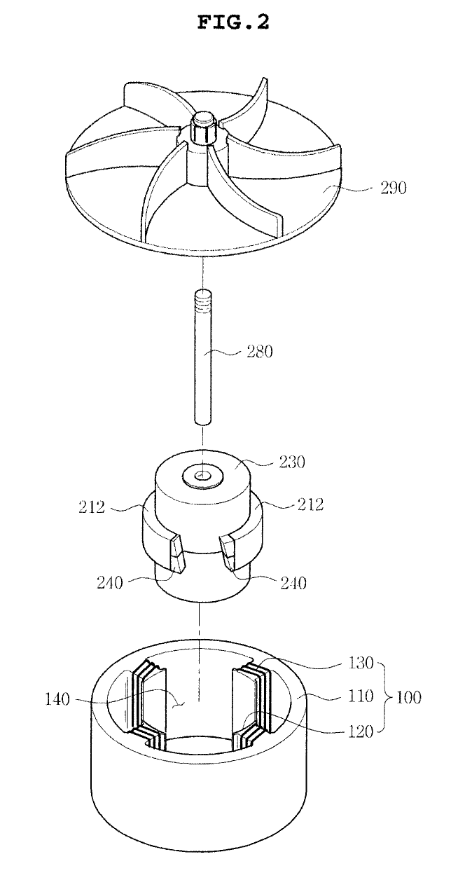

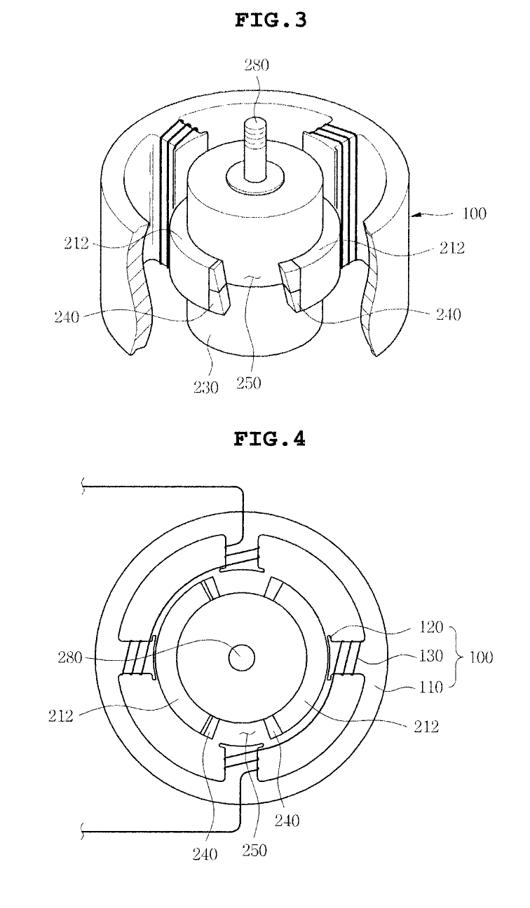

FIG. 2 is a schematic exploded perspective view of a switched reluctance motor according to a preferred embodiment of the present invention; FIG. 3 is a schematic assembled perspective view of the switched reluctance motor shown in FIG. 2; and FIG. 4 is a schematic plan view of the switched reluctance motor shown in FIG. 2. As shown, the switched reluctance motor according to the preferred embodiment of the present invention is configured to include a stator part 100 and a rotor part 200.

More specifically, the stator part 100 includes a yoke 110 having a reception hole 140 formed therein and a plurality of salient poles 120 formed to be protruded at predetermined intervals along an inner peripheral surface of the yoke 110.

In addition, each of the stator salient poles 120 includes a coil 130 wound multiple times therearound in order to receive power from the outside.

Further, the rotor part 200 includes a rotor 210 and a blade part 220.

More specifically, the rotor 210 includes a rotor core 211 having a shaft hole 213 formed at the center thereof, wherein the shaft hole 213 has a shaft 280 inserted thereinto.

In addition, the rotor 210 includes a plurality of rotor salient poles 212 formed to be protruded from the rotor core 211 so as to face the plurality of salient poles 120 of the stator part 100.

Further, the blade part 220 includes a blade body 230 and a plurality of blades 240 formed to be protruded from the blade body 230.

In addition, the plurality of blades 240 are disposed between the rotor salient poles 212 to thereby generate a fluid flow in a direction of the shaft 280.

Further, the shaft 280 includes a fan 290 coupled to one end thereof. The switched reluctance motor may be used for a vacuum cleaner sucking an external fluid or a fan-motor capable of sucking and discharging an external fluid by arbitrarily selecting a rotation direction of the rotor part 200.

As shown, since the rotor 210 according to the preferred embodiment of the present invention includes two rotor salient poles 212 formed to be protruded from the rotor core 211, the stator part 100 includes four salient poles 120 formed to be protruded from the yoke 110.

In addition, the number of rotor salient poles 212 and the number of salient poles 120 of the stator part 100 are not limited thereto. However, the number of rotor salient poles 212 and the number of salient poles 120 of the stator part 100 may be various ratios such as 4:6, 6:8, or the like, therebetween.

As shown in FIG. 3, the plurality of blades 240 are formed to be protruded from the blade part 220 so as to contact sides of the rotor salient poles 212.

Therefore, a fluid penetration part 250 allowing fluid sucked from the outside by the fan 290 to pass through an inner portion of the motor and be then discharged to the outside is formed between the blades 240.

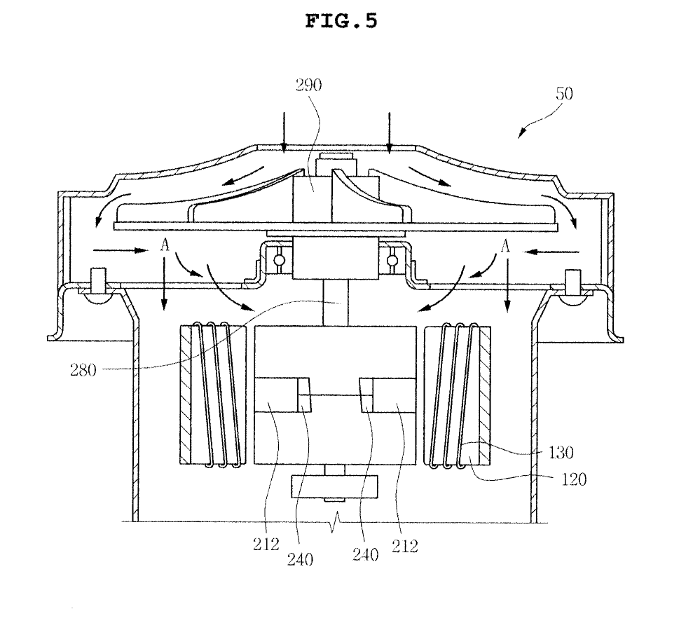

FIG. 4 is a schematic plan view of the switched reluctance motor shown in FIG. 2; and FIG. 5 is a view showing an inner portion of a vacuum cleaner in which the switched reluctance motor shown in FIG. 2 is mounted. As shown, when current flows in the coil 130, a reluctance torque is generated between the stator part 100 and the rotor part 200, such that the shaft 280 rotates together with the rotor part 200 in any direction.

In addition, a relatively lower pressure is generated at the inner portion of the motor, more specifically, between the stator part 100 and the rotor part 200 than at an outer portion of the motor, more specifically, at an outer portion of the stator part 100 by the plurality of blades 240 disposed on the sides of the rotor salient poles 212, a fluid flow in the direction of the shaft 280 occurs.

As shown in FIG. 5, an external fluid primarily sucked by the fan 290 is introduced into the inner portion of the motor of the vacuum cleaner.

Then, since a relatively low pressure is generated in the vicinity of the outer portion of the motor by the plurality of blades 240 configuring the blade part 220 as described above, the introduced fluid is divided in two directions at approximately an A point.

More specifically, the introduced fluid is divided into fluid flowing in a direction toward the outer portion of the motor, that is, a direction toward the outer portion of the stator part 100 and fluid introduced into the inner portion of the motor, more specifically, between the stator part 100 and the rotor part 200, by the fluid flow generated in the direction of the shaft 280.

More specifically, FIG. 12 is an analyzing view analyzing suction force of a rotor part according to the preferred embodiment of the present invention. As shown, in the case of the motor including the plurality of blades, a difference is generated between pressure at an inlet side at which the external fluid is introduced and pressure at an outer side at which the fluid introduced into the inner portion of the motor is discharged.

Under test conditions in which a rotational speed of the rotor is 39,000 rpm and a speed at an inlet side Input A is 20 m/s, a pressure difference between inlet side Input A and an outlet side Output B in a case in which the plurality of blades are disposed on the sides of the rotor salient poles and a case in which the plurality of blades are not disposed on the sides of the rotor salient poles were analyzed.

TABLE 1

| Whether or not blades are present | Note | Note |
|---|---|---|
| No | -632.4 | 0 |
| Four | -527.1 | 105.3 |

It may be confirmed from Table 1 that a pressure difference of about 105 Pa is generated by the plurality of blades disposed on the sides of the rotor salient poles.

Therefore, according to the preferred embodiment of the present invention, since the pressure difference is generated between the inlet side and the outlet side of the motor by the plurality of blades disposed on the sides of the rotor salient poles, the fluid flow is generated in the direction of the shaft, such that the fluid is introduced into the inner portion of the motor.

In addition, the pressure difference between the inlet side Input A and the outlet side Output B means suction force sucking the fluid.

More specifically, when the fluid is primarily introduced from the outside of the fan 290, the fluid is more effectively introduced into the inner portion of the motor along the fluid penetration part formed by the blades, such that fluid suction force of the motor is increased.

When the switched reluctance motor is applied to a general vacuum cleaner in which a suction speed of an external fluid has a stepwise different level, even though the vacuum cleaner is driven at a low speed, the vacuum cleaner may easily suck the external fluid using the fluid suction force increased due to the plurality of blades.

In addition, a larger pressure difference may be generated according to the number of blades, which means that a large amount of fluid may be introduced into the inner portion of the motor. Therefore, in the present invention, the number of blades disposed between the rotor salient poles is not limited.

As described above, the pressure difference is generated by the plurality of blades, such that fluid suction force may be improved and heat of the inner potion of the motor may be radiated.

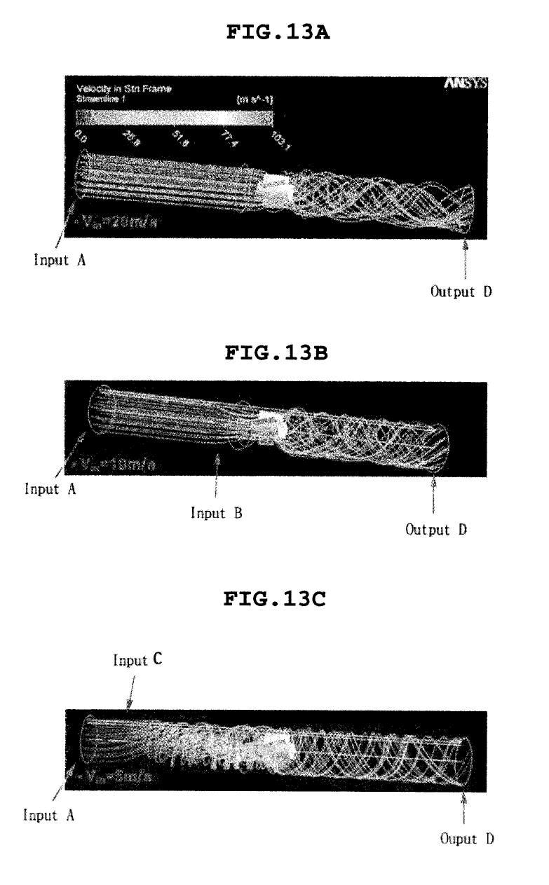

More specifically, FIGS. 13A to 13C are simulation analyzing views analyzing suction force of a rotor part according to a change in introduction speed of fluid according to the preferred embodiment of the present invention.

As shown, FLUENT was used as a simulation program and simulation was performed in simulation conditions in which rotation of the shaft is 39,000 rpm and the number of blades disposed on the sides of the rotor salient poles is 6.

Further, as shown, the simulation was performed while changing a speed of introduced fluid, that is, at 20 m/s in FIG. 13A, at 10 m/s in FIG. 13B, and 5 m/s in FIG. 13C, as a variable for simulation.

As shown in FIGS. 13A to 13C, when the introduction speed of the introduced fluid is rapid in a predetermined level such as 20 m/s, which is a test condition, the fluid is naturally introduced into the inner portion of the motor.

On the other hand, when the introduction speed of the introduced fluid is relatively slower than 20 m/s, such as 10 m/s or 5 m/s which are test conditions, the pressure difference between the inner and outer portions of the motor is generated by the plurality of blades disposed on the sides of the rotor salient poles, as described above.

Therefore, the fluid introduced from the outside at a low speed is sucked at a more rapid speed from Input B point when the fluid is introduced at 10 m/s as shown in FIG. 13B and from Input C point when the fluid is introduced at 5 m/s as shown in FIG. 13C toward between the stator part and the rotor part positioned at the inner portion of the motor.

Therefore, the fluid introduced from the outside is sucked into the inner portion of the motor as described above, and the fluid sucked into the inner portion of the motor passes through an empty space of the stator part 100 and the rotor part 200.

At this time, a convective heat transfer phenomenon is generated by the fluid passing through the surrounding area of the stator part 100 and the rotor part 200, such that heat generated at the inner portion of the motor is radiated.

Therefore, according to the preferred embodiment of the present invention, the plurality of blades are provided to induce a flux component in the direction of the shaft into the inner portion of the motor, such that the overheated inner portion of the motor is cooled, thereby making it possible to prevent a damage of the motor.

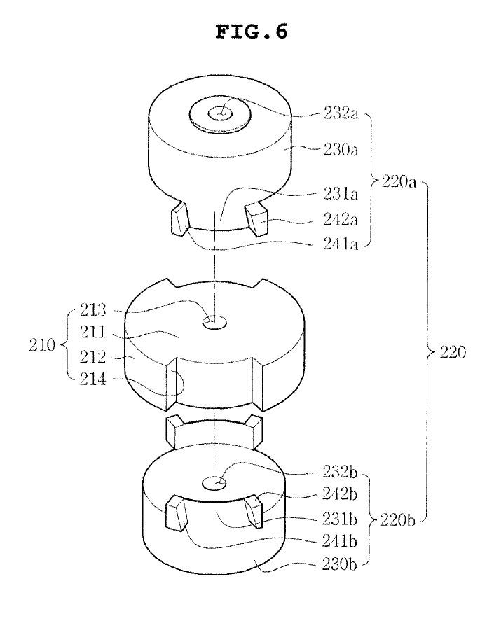

FIG. 6 is an exploded perspective view showing a first example of a blade part according to the preferred embodiment of the present invention.

As described above, the rotor 210 includes the rotor core 211 having the shaft hole 213 formed at the center thereof, wherein the shaft hole 213 has a shaft 280 inserted thereinto.

In addition, the rotor 210 includes the plurality of rotor salient poles 212 formed to be protruded from the rotor core 211 so as to face the plurality of salient poles 120 of the stator part 100.

Further, as shown, the blade part 220 includes a first blade part 220a coupled to an upper portion of the rotor 210 and a second blade part 220b coupled to a lower portion of the rotor 210.

Further, the first blade part 220a is provided with a hollow hole 232a corresponding to the shaft hole 213 and includes a first blade body 230a covering a portion of an outer peripheral surface between the rotor salient poles 212 and a plurality of first blades 241a and 242a.

More specifically, the plurality of first blades 241a and 242a are formed to be protruded from a region of a first blade body 231a covering the rotor salient poles 212 to thereby contact the sides 214 of the rotor salient poles 212.

Further, the second blade part 220b includes a second blade body 230b covering a portion of the outer peripheral surface between the rotor salient poles 212 and a plurality of second blades 241b and 242b.

More specifically, the blade body 230b is provided with a hollow hole 232b corresponding to the shaft hole 213 and the hollow hole 232a formed in the blade body 230a configuring the first blade part 220a.

Therefore, the shaft 280 is fixedly coupled to the hollow hole 232a formed in the first blade body 230a and the hollow hole 232b formed in the second blade body 230b while penetrating therethrough.

More specifically, the plurality of second blades 241b and 242b are formed to be protruded from a region of the second blade body 231b covering the rotor salient poles 212 to thereby contact the sides 214 of the rotor salient poles 212.

Further, since the second blade part 220b is coupled to the lower portion of the rotor 210, the second blades 241b and 242b contact lower portions of the first blades 241a and 242a.

More specifically, as shown, the first blade 241a configuring the first blade part 220a is connected to the second blade 241b configuring the second blade part 220b to configure one blade 240.

In addition, another first blade 242a configuring the first blade part 220a is connected to another second blade 242b configuring the second blade part 220b to form another blade 240.

Further, the first and second blade parts 220a and 220b are made of the same material, particularly, a plastic material or a resin material, which is a non-magnetic insulating material that does not conduct current.

In addition, in the first and second blade parts 220a and 220b made of the plastic material or the resin material, which is the non-magnetic insulating material, regions other than regions at which the plurality of first blades 241a and 242a and second blades 241b and 242b are formed to be protruded may be processed to have various shapes in order to balance the rotor part 200 configuring the switched reluctance motor.

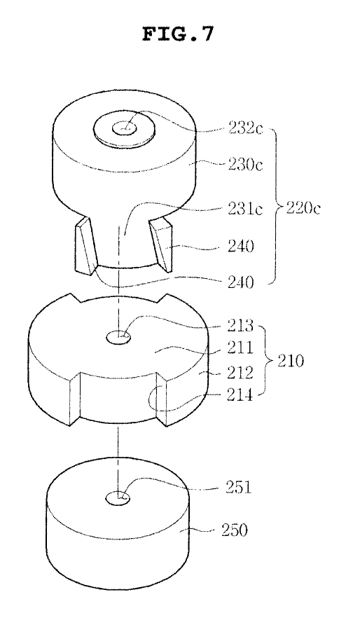

FIG. 7 is an exploded perspective view showing a second example of a blade part according to the preferred embodiment of the present invention. In describing the present example, the same or corresponding components to the foregoing preferred embodiments are denoted by the same reference numerals and therefore, the description of the overlapping portions will be omitted. Hereinafter, the blade part according to the present example will be described with reference to FIG. 7.

As shown, a blade part 220c is coupled to the upper portion of the rotor 210 and includes an upper blade body 230c covering an outer peripheral surface between the rotor salient poles 212 and a plurality of blades 240 formed to be protruded from the upper blade body 230c.

In addition, the upper blade body 230c is provided with a hollow hole 232c corresponding to the shaft hole 213, such that the shaft 280 is fixedly coupled thereto while penetrating therethrough.

Further, the plurality of blades 240 are formed to be protruded from a region of the upper blade body 231c covering the rotor salient poles 212 to thereby contact the sides 214 of the rotor salient poles 212.

In addition, the blade part 220c may be made of a plastic material or a resin material, which is a non-magnetic insulating material.

Furthermore, a balance part 250 made of the plastic material or the resin material, which is the non-magnetic insulating material, and provided with a hollow hole 251 corresponding to the shaft hole 213 and the hollow hole 232c formed in the upper blade body 230c may be coupled to the lower portion of the rotor 210.

Therefore, regions of the blade part 220c other than regions at which the plurality of blades 240 are formed to be protruded and the balancing part 250 may be processed to have various shapes in order to balance the rotor part 200 configuring the switched reluctance motor.

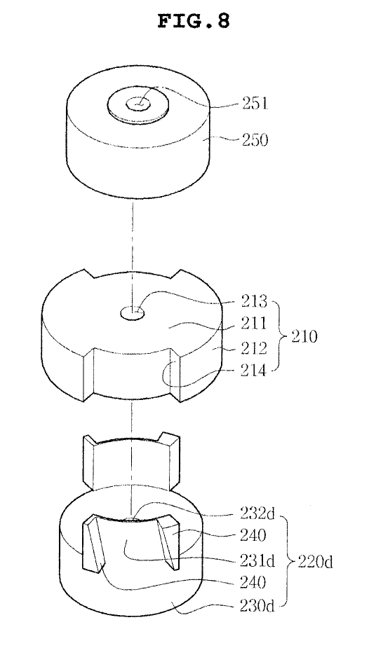

FIG. 8 is an exploded perspective view showing a third example of a blade part according to the preferred embodiment of the present invention. In describing the present example, the same or corresponding components to the foregoing preferred embodiments are denoted by the same reference numerals and therefore, the description of the overlapping portions will be omitted. Hereinafter, the blade part according to the present example will be described with reference to FIG. 8.

As shown, the blade part 220d is coupled to the lower portion of the rotor 210 and includes a lower blade body 230d covering an outer peripheral surface between the rotor salient poles 212 and a plurality of blades 240 formed to be protruded from the lower blade body 230d.

In addition, the lower blade body 230d is provided with a hollow hole 232d corresponding to the shaft hole 213, such that the shaft 280 is fixedly coupled thereto while penetrating therethrough.

Further, the plurality of blades 240 are formed to be protruded from a region of the lower blade body 231d covering the rotor salient poles 212 to thereby contact the sides 214 of the rotor salient poles 212.

In addition, the blade part 240 may be made of a plastic material or a resin material, which is a non-magnetic insulating material.

Furthermore, a balance part 250 made of the plastic material or the resin material, which is the non-magnetic insulating material, and provided with a hollow hole 251 corresponding to the shaft hole 213 and the hollow hole 232d formed in the lower blade body 230d may be coupled to the upper portion of the rotor 210.

Therefore, regions of the blade part 220d other than regions at which the plurality of blades 240 are formed to be protruded and the balancing part 250 may be processed to have various shapes in order to balance the rotor part 200 configuring the switched reluctance motor.

FIG. 9 is an assembled perspective view showing a fourth example of a blade part according to the preferred embodiment of the present invention. In describing the present example, the same or corresponding components to the foregoing preferred embodiments are denoted by the same reference numerals and therefore, the description of the overlapping portions will be omitted. Hereinafter, the blade part according to the present example will be described with reference to FIG. 9.

The fourth example of the blade part 220 further includes a plurality of upper salient poles 243a formed to be protruded from the first blade part 220a and a plurality of lower salient poles 243b formed to be protruded from the second blade part 220b, as compared to the first example of the blade part according to the preferred embodiment of the present invention.

More specifically, the upper salient poles 243a are formed to be protruded from the first blade body 230a so as to be disposed between the blades 241a and 242a configuring the first blade part 220a.

In addition, the lower salient poles 243b are formed to be protruded from the second blade body 230b so as to be disposed between the blades 241b and 242b configuring the second blade part 220b.

Therefore, the plurality of salient poles 243a formed to be protruded from the first blade body 230a and the plurality of salient poles 243b formed to be protruded from the second blade body 230b are vertically connected to each other to thereby form a plurality of auxiliary blades.

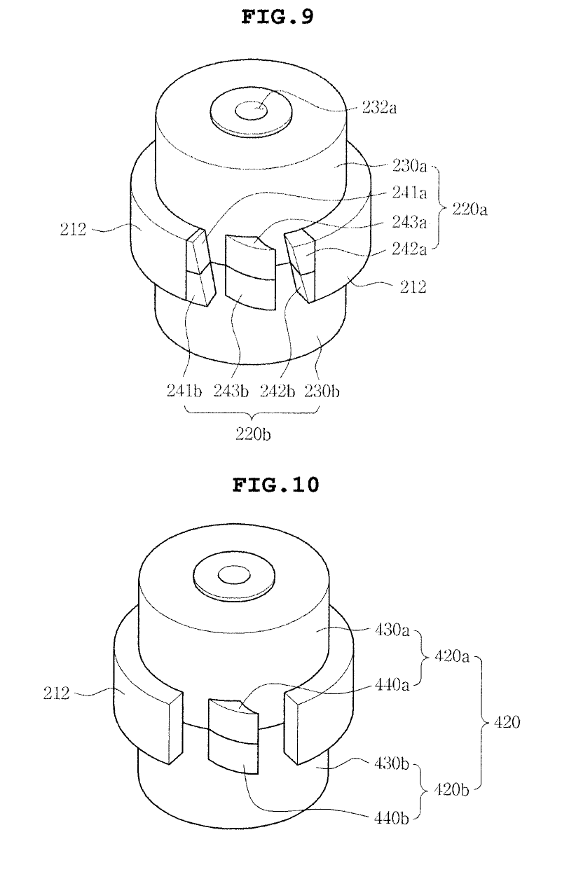

FIG. 10 is an assembled perspective view showing a fifth example of a blade part according to the preferred embodiment of the present invention. In describing the present example, the same or corresponding components to the foregoing preferred embodiments are denoted by the same reference numerals and therefore, the description of the overlapping portions will be omitted. Hereinafter, the blade part according to the present example will be described with reference to FIG. 10.

The blade part 420 includes a first blade part 420a coupled to the upper portion of the rotor 210 and a second blade part 420b coupled to the lower portion of the rotor 210.

Further, the first blade part 420a is provided with a hollow hole (not shown) corresponding to the shaft 280 and includes a blade body 430a covering a portion of the outer peripheral surface between the rotor salient poles 212 and a plurality of salient poles 440a formed to be protruded from the blade body 430a.

More specifically, the salient poles 440a are formed to be protruded from the blade body 430a covering an outer peripheral surface between the rotor salient poles 212.

Further, the second blade part 420b is provided with a hollow hole (not shown) corresponding to the shaft hole 213 and the hollow hole (not shown) formed in the blade body 430a configuring the first blade part 420a, and includes a blade body 430b covering a portion of the outer peripheral surface between the rotor salient poles 212 and a plurality of salient poles 440b formed to be protruded from the blade body 430b.

More specifically, the salient poles 440b configuring the second blade part 420a are also formed to be protruded from the blade body 430b covering between the rotor salient poles 212 and configuring the second blade part 420b, similar to the salient poles 440a configuring the first blade part 420a.

Therefore, the plurality of salient poles 440a formed to be protruded from the blade body 430a configuring the first blade part 420a and the plurality of salient poles 440b formed to be protruded from the second blade body 430b configuring the second blade part 420b are vertically connected to each other to thereby form a plurality of blade salient poles.

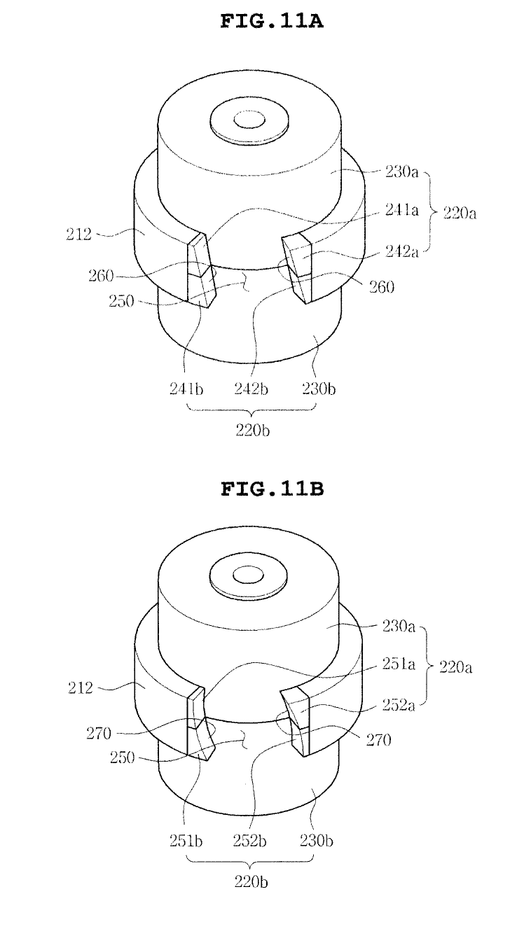

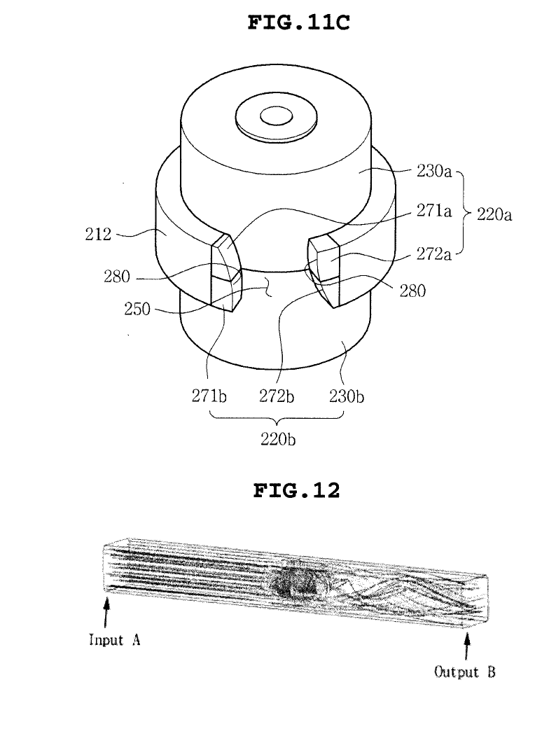

FIGS. 11A to 11C are perspective views showing various examples of a shape of a blade according to the preferred embodiment of the present invention. In describing the present example, the same or corresponding components to the foregoing preferred embodiments are denoted by the same reference numerals and therefore, the description of the overlapping portions will be omitted. Hereinafter, various shapes of the blade according to the present example will be described with reference to FIGS. 11A to 11C.

As shown, the plurality of blades configuring the blade part may be configured so that surfaces thereof contacting the fluid introduced from the outside have various shapes.

More specifically, as shown in FIG. 11A, the blade 240 formed by connecting the first blade 241a and the second blade 241b to each other is configured so that a surface 260 thereof contacting the fluid introduced in the direction of the shaft 280 has a linear shape.

Therefore, an inlet of the fluid penetration part 250 into which the fluid is introduced, a central portion thereof, and an outlet thereof from which the fluid is discharged have the same area.

In addition, as shown in FIG. 11B, the blade 240 formed by connecting the first blade 251a and the second blade 251b to each other is configured so that a surface 270 thereof contacting the fluid introduced in the direction of the shaft 280 has a concave curved shape.

More specifically, the surface 270 of the blade contacting the fluid is formed as a curved surface rounded to be concave toward the rotor salient pole 212 contacting the side of the blade 240.

Therefore, since the fluid penetration part 250 is configured as a concave curved path, an area is gradually increased from the inlet of the fluid penetration part 250 into which the fluid is introduced toward the central portion thereof, such that the area of the central portion is significantly larger than that of the inlet, and an area is gradually decreased from the central portion thereof toward the outlet thereof from which the fluid is discharged, such that the area of the outlet is the same as that of the inlet.

Further, as shown in FIG. 11C, one blade 240 is formed by connecting the first and second blades 271a and 272b to each other.

In addition, another blade 240 facing the blade 240 is formed by connecting the first and second blades 272a and 272b to each other.

Further, the blade 240 is configured so that a surface 280 thereof contacting the fluid introduced in the direction of the shaft 280 has a convex curved shape.

More specifically, the surface 280 of the blade contacting the fluid is formed as a curved surface rounded to be convex toward another blade 240 facing the blade 240.

Therefore, since the fluid penetration part 250 is configured as a convex curved path, an area is wide at the inlet of the fluid penetration part 250 into which the fluid is introduced, is gradually decreased toward the central portion thereof, such that the area of the central portion is significantly narrower than that of the inlet, and an area is gradually increased from the central portion thereof toward the outlet thereof from which the fluid is discharged, such that the area of the outlet is the same as that of the inlet.

Therefore, the shapes of the blades disposed on the rotor salient pole are variously changed so as to be the same as the direction of the shaft, thereby making it possible to variously change a magnitude of a flux induced in the direction of the shaft.

Therefore, the shape of the blade configuring the blade part coupled integrally with the rotor is simply changed, thereby making it possible to diversify a range of suction force generally required by the vacuum cleaner. As a result, it is possible to manufacture a vacuum cleaner having various ranges of suction force.

According to the preferred embodiments of the present invention, the plurality of blades are disposed between the rotor salient poles to generate the fluid flow in the direction of the shaft at the time of rotation of the rotor, thereby making it possible to improve suction force of the fluid of the switched reluctance motor.

In addition, the heat generated at the inner portion of the motor is spontaneously radiated by the increased fluid flow, thereby making it possible to improve cooling characteristics of the switched reluctance motor.

Further, the blade part including the plurality of blades is made of the plastic material or the resin material, which is the non-magnetic insulating material, thereby making it possible to maintain a balance of the rotor part.

Although the preferred embodiments of the present invention have been disclosed for illustrative purposes, they are for specifically explaining the present invention and thus a switched reluctance motor according to the present invention is not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A switched reluctance motor comprising:
a stator part including a plurality of salient poles formed at an inner peripheral surface thereof and coils wound around the salient poles; and
a rotor part rotatably inserted into an inner portion of the stator part to thereby rotate in one direction by a reluctance torque,
wherein the rotor part includes:
a rotor including a rotor core provided with a shaft hole into which a shaft is inserted and a plurality of rotor salient poles formed to be protruded from the rotor core so as to face the salient poles of the stator part; and
a blade part disposed between the rotor salient poles to thereby generate a fluid flow in a direction of the shaft.

2. The switched reluctance motor as set forth in claim 1, wherein the blade part includes:
a first blade part provided with a hollow hole corresponding to the shaft hole and including a first blade body coupled to an upper portion of the rotor and a plurality of first blades formed to be protruded from the first blade body; and
a second blade part provided with a hollow hole corresponding to the shaft hole and including a second blade body coupled to a lower portion of the rotor and a plurality of second blades formed to be protruded from the second blade body.

3. The switched reluctance motor as set forth in claim 2, wherein the blade part is formed by vertically connecting the first blade configuring the first blade part and the second blade configuring the second blade part to each other.

4. The switched reluctance motor as set forth in claim 2, wherein the first blade body covers a portion of an outer peripheral surface between the rotor salient poles.

5. The switched reluctance motor as set forth in claim 4, wherein the first blade is formed to be protruded from a region of the first blade body covering a portion of the outer peripheral surface between the rotor salient poles to thereby be disposed on a side of the rotor salient pole.

6. The switched reluctance motor as set forth in claim 2, wherein the second blade body covers a portion of an outer peripheral surface between the rotor salient poles.

7. The switched reluctance motor as set forth in claim 6, wherein the second blade is formed to be protruded from a region of the second blade body covering a portion of the outer peripheral surface between the rotor salient poles to thereby be disposed on a side of the rotor salient pole.

8. The switched reluctance motor as set forth in claim 1, wherein the blade part includes:
an upper blade body provided with a hollow hole corresponding to the shaft hole, coupled to an upper portion of the rotor, and having a partial region covering an outer peripheral surface between the rotor salient poles; and
a plurality of blades formed to be protruded from a region of the upper blade body positioned between the rotor salient poles to thereby be disposed on a side of the rotor salient pole.

9. The switched reluctance motor as set forth in claim 8, wherein the rotor part further includes a balancing part made of a non-magnetic insulating material and provided with a hollow hole corresponding to the shaft hole to thereby be coupled to a lower portion of the rotor core.

10. The switched reluctance motor as set forth in claim 1, wherein the blade part includes:
a lower blade body provided with a hollow hole corresponding to the shaft hole, coupled to a lower portion of the rotor, and having a partial region covering an outer peripheral surface between the rotor salient poles; and
a plurality of blades formed to be protruded from a region of the lower blade body positioned between the rotor salient poles to thereby be disposed on a side of the rotor salient pole.

11. The switched reluctance motor as set forth in claim 10, wherein the rotor part further includes a balancing part made of a non-magnetic insulating material and provided with a hollow hole corresponding to the shaft hole to thereby be coupled to an upper portion of the rotor core.

12. The switched reluctance motor as set forth in claim 2, wherein the first blade part further includes a plurality of salient poles formed to be protruded from the first blade body so as to be disposed between the first blades of the first blade part.

13. The switched reluctance motor as set forth in claim 2, wherein the second blade part further includes a plurality of salient poles formed to be protruded from the second blade body so as to be disposed between the second blades of the second blade part.

14. The switched reluctance motor as set forth in claim 1, wherein the blade part includes:
a first blade part including a first blade body provided with a hollow hole corresponding to the shaft hole, coupled to an upper portion of the rotor, and having a partial region covering an outer peripheral surface between the rotor salient poles and a plurality of salient poles formed to be protruded from a region of the first blade body positioned between the rotor salient poles; and
a second blade part including a second blade body provided with a hollow hole corresponding to the shaft hole, coupled to a lower portion of the rotor, and having a partial region covering an outer peripheral surface between the rotor salient poles and a plurality of salient poles formed to be protruded from a region of the second blade body positioned between the rotor salient poles.

15. The switched reluctance motor as set forth in claim 14, wherein in the blade part, the plurality of salient poles formed to be protruded from the first blade body and the plurality of salient poles formed to be protruded from the second blade body are vertically connected to each other to thereby form a plurality of blade salient poles.

16. The switched reluctance motor as set forth in claim 1, wherein in the blade part, a surface of the blade contacting fluid introduced in the direction of the shaft has a linear shape.

17. The switched reluctance motor as set forth in claim 1, wherein in the blade part, a surface of the blade contacting fluid introduced in the direction of the shaft is formed to be concave toward the rotor salient pole coupled to a side of the blade to thereby have a rounded curved shape.

18. The switched reluctance motor as set forth in claim 1, wherein in the blade part, a surface of the blade contacting fluid introduced in the direction of the shaft is formed to be convex toward another facing blade to thereby have a rounded curved shape.
